(19) United States
(12) Patent Application Publication
(10) Pub. No.: US 2018/0353042 A1
(43) Pub. Date: Dec. 13, 2018

(54) CLEANING ROBOT AND CONTROLLING METHOD THEREOF

(71) Applicant: Samsung Electronics Co., Ltd., Suwon-si (KR)

(72) Inventors: Hwan-hee GIL, Suwon-si (KR); Jun-pyo HONG, Suwon-si (KR)

(21) Appl. No.: 15/995,575

(22) Filed: Jun. 1, 2018

(30) Foreign Application Priority Data
Jun. 8, 2017 (KR) 10-2017-0071833

(51) Int. Cl. A47L 11/40; G05D 1/00; G05D 1/02

(52) U.S. Cl. CPC A47L 11/4011; A47L 11/4044; G05D 2201/0215; G05D 1/0221; A47L 2201/04; G05D 1/0088

(57) ABSTRACT

A cleaning robot is provided. The cleaning robot includes a distance measuring sensor configured to measure distance information to an object located outside the cleaning robot, a memory configured to store a shape of the object, the distance information, and a plurality of commands based on the distance information to the object which is measured through the distance measuring sensor, and a processor configured to, when the cleaning robot is operated, estimate a type of the object by applying the shape of the object and the distance information stored in the memory to a learning network model configured to estimate a type of the object, and when the object is in a type that the object is to be avoided, re-set a driving route of the cleaning robot, and when the type of the object is an object to be driven, perform the commands which are set to maintain a driving route of the cleaning robot in progress, wherein the learning network model which is configured to estimate the type of the object is a learning network model which learns using a shape of the object, distance information to the object, and information of a type of the object.

### CROSS-REFERENCE TO RELATED APPLICATION(S)

This application is based on and claims priority under 35 U.S.C. § 119(a) of a Korean patent application number 10-2017-0071833, filed on Jun. 8, 2017, in the Korean Intellectual Property Office, the disclosure of which is incorporated by reference herein in its entirety.

### TECHNICAL FIELD

The disclosure relates to a display apparatus and a controlling method thereof. More particularly, the disclosure relates to a cleaning robot which resets or maintains a driving route based on a type of an object detected by the cleaning robot or a controlling method thereof.

### BACKGROUND

A cleaning robot is a device for automatically cleaning the cleaning space by suctioning foreign substances, such as dust accumulated on the floor while driving the cleaning space without user's operation.

A household cleaning robot can carry out self-cleaning on the floor with the purpose of cleaning the floor with a dry cleaning tool, a wet cleaning tool, or a dry-wet cleaning tool.

The cleaning robot can use various types of sensors to detect various objects encountered during cleaning (for example, walls, furniture, stairs, and the like).

The cleaning robot detects an object located on a moving route by using various sensors, but it is difficult to determine whether to continue the cleaning or avoid an object by classifying the object type.

Therefore, a need exists for a cleaning robot which resets or maintains a driving route based on a type of an object detected by the cleaning robot or a controlling method thereof.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a cleaning robot which resets or maintains a driving route based on a type of an object detected by the cleaning robot or a controlling method thereof.

If cleaning is performed on an object that is substantially impossible to clean, there may be a problem that a larger area is contaminated by contaminants contained in the object rather than the object is cleaned. For example, if animal excrement is an obstacle, the cleaning robot cannot avoid the obstacle, and the wider area may be contaminated by the excrement as the cleaning robot continues cleaning.

Accordingly, recent new technologies can be considered for efficient driving of a cleaning robot. For example, the shape of the object is derived based on the distance information with the object, and the image processing technique utilizing the artificial intelligence (AI) system as well as the database search for the derived shape is emerging. The AI system is a computer system that implements human-level intelligence. It is a system in which the machine learns, judges and improves recognition rate as it is used. AI technology consists of element technologies that simulate functions of recognition, judgment, and the like of human brain using learning network model that uses algorithm to classify/learn input data by itself.

Elemental technologies include, for example, linguistic comprehension techniques for recognizing human language/characters, visual comprehension techniques for recognizing objects as human vision, reasoning/predicting techniques for determining information and logically reasoning and predicting, knowledge expression technique for processing experience information of human as knowledge data, and an operation control technology for controlling an autonomous driving of a vehicle, and an operation of a robot. Among these technologies, visual understanding is a technique to recognize and process things like human vision, including object recognition, object tracking, image search, human recognition, scene understanding, spatial understanding, image enhancement, and the like.

Accordingly, an aspect of the disclosure is to utilize this artificial intelligence (AI) technology to estimate the type of object by the cleaning robot, and to reset the moving route according to the estimated object type, thereby performing efficient driving for cleaning.

In addition, it is to be understood that the technical subject matter of the disclosure is not limited to the above-described technical objects, and other technical objects which are not mentioned can be clearly understood from the following description.

In accordance with an aspect of the disclosure, a cleaning robot is provided. The cleaning robot includes a distance measuring sensor configured to measure distance information with an object located outside the cleaning robot, a memory configured to store a shape of the object, the distance information, and a plurality of commands based on the distance information with the object which is measured through the distance measuring sensor, and a processor configured to, when the cleaning robot is operated, estimate a type of the object by applying the shape of the object and the distance information stored in the memory to a learning network model configured to estimate a type of the object, and when the object is in a type that the object is to be avoided, re-set a driving route of the cleaning robot, and when the type of the object is an object to be driven, perform the commands which are set to maintain a driving route of the cleaning robot in progress, wherein the learning network model which is configured to estimate the type of the object is a learning network model which learns using a shape of the object, distance information with the object, and information of a type of the object.

In accordance with another aspect of the disclosure, a controlling method for a cleaning robot is provided. The controlling method includes obtaining distance information with an object located at outside of the cleaning robot, deriving a shape of the object based on distance information with the object, estimating a type of the object by applying the distance information and a shape of the object to a learning network model configured to estimate a type of an object, and when a type of the estimated object is an object to be avoided, resetting a driving route of the cleaning robot in progress, and when a type of the estimated object is an object to be driven, maintaining a driving route of the cleaning robot, wherein the learning network model which is set to estimate a type of the object is a learning network model which is learnt using a shape of an object, distance information with the object, and information of the type of the object.

According to the disclosure, when a type of an object is estimated from an outer shape of an object derived by using a learning network model, driving performance of a cleaning robot can be improved.

Further, in order to improve the driving performance of the cleaning robot, it is not necessary to input a new image into the database, and the pre-generated learning network model is continuously learned, so that the cleaning robot can be easily and efficiently managed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a perspective view seeing a cleaning robot from an upper side according to an embodiment of the disclosure;

FIG. 1B is a view seeing a cleaning robot from a bottom side of the cleaning robot according to an embodiment of the disclosure;

FIG. 2A is a brief block diagram of a cleaning robot according to an embodiment of the disclosure;

FIGS. 2B and 2C illustrate a situation to update a learning network model by reflecting data recognition using a learning network model and a data recognition result to a learning network model again according to various embodiments of the disclosure;

FIGS. 3A and 3B illustrate a process for determining a type of an object by a cleaning robot according to various embodiments of the disclosure;

FIG. 4 illustrates a process for generating a learning network model according to an embodiment.

FIGS. 5A, 5B, 5C, and 5D illustrate a situation of detecting an object by a cleaning robot and resetting a driving route according to various embodiments of the disclosure;

FIGS. 6A, 6B, 6C, and 6D illustrate a situation of detecting an object by a cleaning robot and resetting a driving route according to various embodiments of the disclosure;

FIGS. 7A, 7B, and 7C illustrate a situation of detecting an object by a cleaning robot and resetting a driving route according to various embodiments of the disclosure;

FIGS. 8A and 8B illustrate a driving method of the cleaning robot according to various embodiments of the disclosure;

FIGS. 9A, 9B, and 9C illustrate a user interface (UI) for adjusting a degree of driving route resetting of the cleaning robot according to various embodiments of the disclosure;

FIG. 10 illustrates a situation in which a location of a sensor for measuring distance with an object from the cleaning robot is set differently according to an embodiment of the disclosure; and

FIG. 11 is a flowchart illustrating a driving method of a cleaning robot according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the following description, like drawing reference numerals are used for like elements, even in different drawings. The matters defined in the description, such as detailed construction and elements, are provided to assist in a comprehensive understanding of the various embodiments of the disclosure. However, it is apparent that the various embodiments may be practiced without those specifically defined matters. In addition, well-known functions or constructions are not described in detail since they would obscure the description with unnecessary detail.

The terms, such as “first,” “second,” and so on may be used to describe a variety of elements, but the elements should not be limited by these terms. The terms are used only for the purpose of distinguishing one element from another.

A singular expression includes a plural expression, unless otherwise specified. It is to be understood that the terms, such as “comprise” or “consist of” are used herein to designate a presence of characteristic, number, operation, element, component, or a combination thereof, and not to preclude a presence or a possibility of adding one or more of other characteristics, numbers, operations, elements, components or a combination thereof.

In the embodiments of the disclosure, a ‘module’ or a ‘unit’ may perform at least one function or operation, and be implemented as hardware (e.g., circuitry) or software, or as a combination of hardware and software. Further, except for the ‘module’ or the ‘unit’ that has to be implemented as particular hardware (e.g., a dedicated processor), a plurality of ‘modules’ or a plurality of ‘units’ may be integrated into at least one module and implemented as at least one processor.

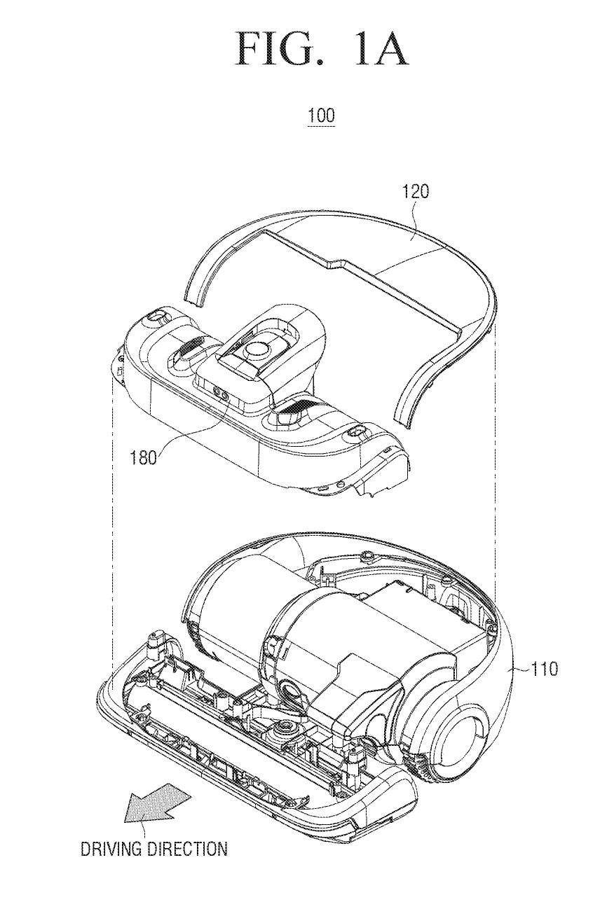

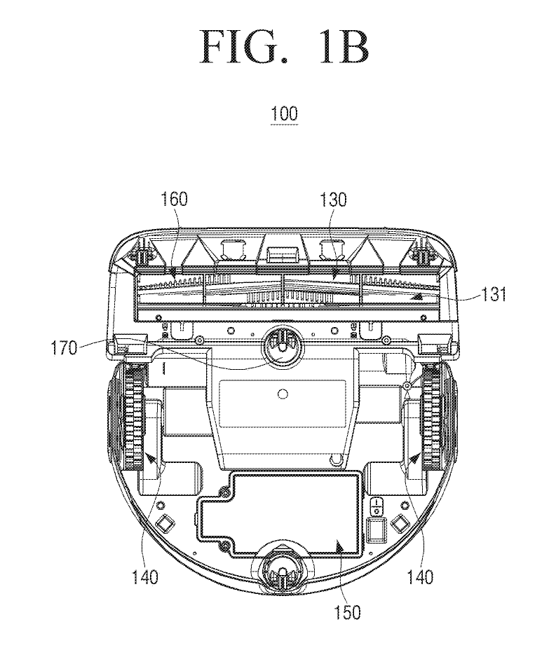

FIGS. 1A and 1B illustrate an outer shape of a cleaning robot according to various embodiments of the disclosure. FIG. 1A is a perspective view seeing a cleaning robot from an upper side. FIG. 1B is a view seeing the cleaning robot from a bottom side of the cleaning robot.

Referring to FIGS. 1A and 1B, a cleaning robot 100 according to an embodiment of the disclosure includes a main body 110 forming an outer shape, a cover 120 covering an upper portion of the main body 110, a cleaning head mounting unit 130 in which a cleaning head which sweeps or scatters dust existing in a cleaning space is mounted, a battery 150 which supplies driving power for driving the main body 110, and a driving motor 140 which drives the main body 110.

The main body 110 forms an outer shape of the cleaning robot 100, and supports various components installed therein. The cleaning head mounting unit 130 is installed in the suction hole 160 formed in the lower portion of the main body 110 to improve the suction efficiency of the dust, thereby sweeping or scattering the dust on the floor.

The cleaning head mounting unit 130 includes a drum-shaped brush unit 131 installed on the suction hole 160 at a length corresponding to the suction hole 160 and rotated in a roller manner with respect to the bottom surface to sweep or scatter dust on the floor surface, and a brush motor (not shown) for rotating the brush unit 131.

Meanwhile, the unit mounted on the cleaning head mounting unit 130 is not limited to the brush unit 131. For example, depending on the cleaning mode, the cleaning head mounting unit 130 may be equipped with various cleaning heads. In addition, a caster wheel 170 is installed in front of the main body 110, and the rotation angle of the caster wheel 170 varies depending on the condition of the bottom surface on which the cleaning robot 100 moves. The caster wheel 170 is utilized for stabilizing a posture and preventing falling of the cleaning robot 100, supports the cleaning robot 100, and is made of a roller or caster-shaped wheel.

In addition, the cleaning robot 100 may provide a sensor 180 (e.g., a 3D camera, a rotation-type light detection and ranging (LiDAR) sensor) on a side which is nearby a driving direction of the cleaning robot 100 in line with a driving direction of the cleaning robot 100. Accordingly, the cleaning robot 100 can obtain distance information with respect to various objects located on the driving route while driving.

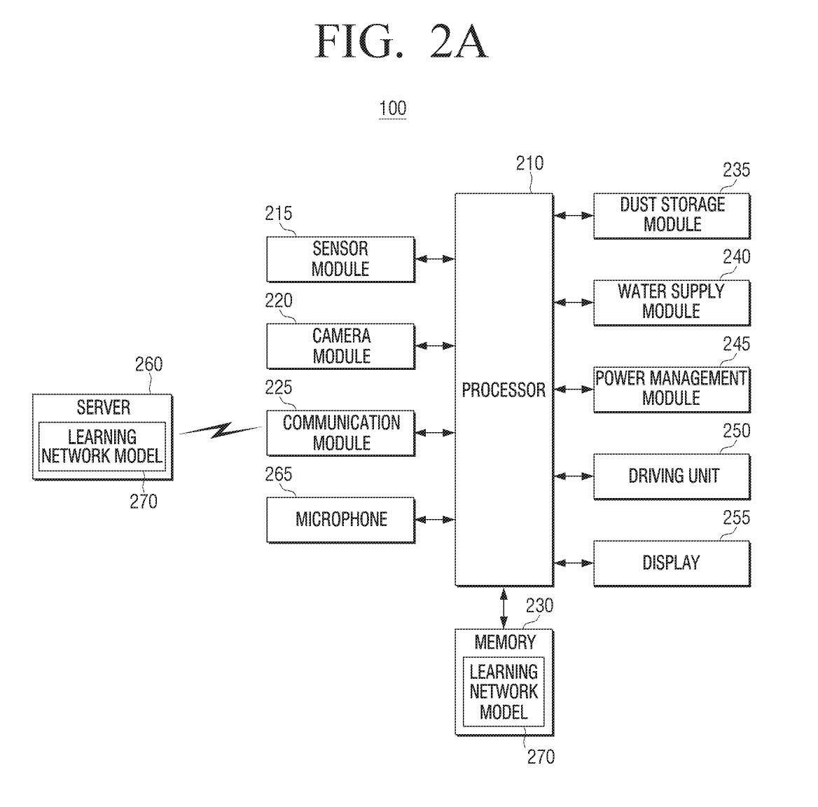

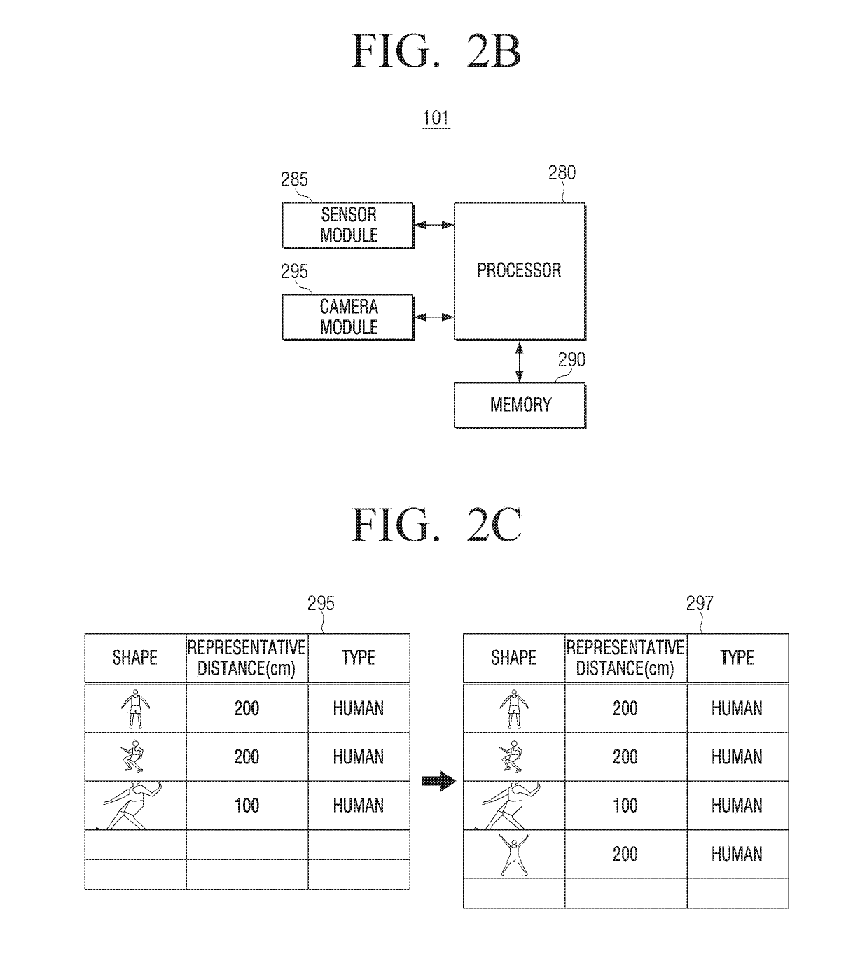

FIG. 2A is a brief block diagram of a cleaning robot according to an embodiment of the disclosure.

Referring to FIG. 2A, the cleaning robot 100 may include a processor 210, a sensor module 215, a camera module 220, a communication module 225, a display 255, a power management module 245, a driving unit 250, a dust storage module 235, a water supply module 240, a microphone 265, and a memory 230. However, the disclosure is not limited thereto, and it may further include components necessary for driving the cleaning robot 100, or may not include some components.

The processor 210 may operate, for example, an operating system or application programs to control a plurality of hardware or software components coupled to the processor 210, and may perform various data processing and operations. The processor 210 may be implemented with, for example, a system on chip (SoC). According to one embodiment, the processor 210 may further include a graphics processing unit (GPU) and/or an image signal processor. The sensor module 215 can, for example, measure the physical quantity or detect the operating state of the cleaning robot 100 and convert the measured or detected information into electrical signals. The sensor module 215 may include, for example, an obstacle sensor, a fall detection sensor, a collision detection sensor, an acceleration sensor, a gyro sensor, a hearing sensor, an infrared sensor, a LiDAR sensor, and a dust box detection sensor, or the like.

The sensor module 215 may further include, for example, a control circuit for controlling at least one or more sensors belonging thereto. In some embodiments, the cleaning robot 100 may further include a processor configured to control the sensor module 215 either as a part of the processor 210 or separately, so as to, while the processor 210 is in a sleep state, control the sensor module 215.

The camera module 220 may include, for example, a general camera (two dimensional (2D) camera), a position recognition camera, a three dimensional (3D) depth camera, and the like. The position-recognition camera can be disposed, for example, on an upper part of the cleaning robot 100 to photograph the moving trace of the cleaning robot 100.

The 3D depth camera can acquire, for example, depth information of an object included in the photographed image. For example, the 3D depth camera can acquire depth information about a subject by acquiring a distance value of each point included in the subject. According to various embodiments, the processor 210 may generate skeletal information of a human using the photographed image and depth information of the subject using a skeleton extraction algorithm. For example, the processor 210 can detect an arm, a leg, a torso, a face, and the like constituting a human body by using a skeleton extraction algorithm.

The communication module 225 may include, for example, a cellular module, a wireless fidelity module, a Bluetooth module, a near field communication (NFC) module, and a radio frequency (RF) module. The cleaning robot 100 can communicate with an external server using a communication module.

The display 255 may be, for example, positioned on the upper surface of the cleaning robot 100 to display various states of the cleaning robot 100, but may be provided at various positions. The display 255 may be implemented by a liquid crystal display (LCD), a light emitting diode (LED), a plasma display panel (PDP), an organic LED (OLED), or a cathode ray tube (CRT), but is not limited thereto.

The power management module 245 may control, for example, the power of the cleaning robot 100. According to one embodiment, the power management module 245 may include a power management integrated circuit (PMIC), a charging IC, or a battery or fuel gauge. The PMIC may have a wired and/or wireless charging system. The wireless charging system may include, for example, a magnetic resonance system, a magnetic induction system, or an electromagnetic wave system, and may further include an additional circuit for wireless charging, for example, a coil loop, a resonant circuit, or a rectifier.

The driving unit 250 can perform, for example, movement or cleaning operation of the cleaning robot 100. The driving unit 250 may include, for example, a wheel motor, a main brush motor, a side brush motor, and the like. However, the disclosure is not limited thereto, and may further include components necessary for driving the cleaning robot 100.

The dust storage module 235 can perform cleaning according to the dry cleaning mode, thereby isolating the dust that is sucked in the sealed space. For example, the dust storage module 235 can control the operation of accommodating the dust sucked from the suction port (for example, the suction hole 160 in FIG. 1B) into the dust container during dry cleaning. The water supply module 240 may refer to a module that controls the supply of water to the cleaning head mount 130 when a wet cleaning is performed.

The microphone 265 can receive the sound around the cleaning robot 100 and recognize the obstacle. For example, the cleaning robot 100 can grasp the position or movement of an animal based on the received direction when the sound of the animal is received through the microphone 265. Memory 230 may include volatile and/or non-volatile memory. The memory 230, for example, may store instructions or data related to at least one other component of the cleaning robot 100.

The memory 230 may store a learning network model 270 according to one embodiment. Learning network model 270 may be designed to simulate the human brain structure on a computer.

For example, the learning network model 270 may include a plurality of weighted network nodes that simulate a neuron of a human neural network. The plurality of network nodes may each establish a connection relationship such that the neurons simulate synaptic activity of sending and receiving signals through synapses.

The learning network model 270 may include, for example, an artificial intelligence (AI) neural network model or a deep learning network model developed in a neural network model. In the deep learning network model, a plurality of network nodes are located at different depths (or layers), and data can be exchanged according to a convolution connection relationship.

The learning network model 270 may be implemented, for example, as a software module. When implemented in a software module (e.g., a program module containing instructions), the learning network model 270 may be stored in a computer readable storage medium. In this case, the computer readable media may be at least a portion of the memory 230.

According to another embodiment, the learning network model 270 may be integrated in a hardware chip form and become a part of the processor 210. For example, the learning network model 270 may be made in the form of a dedicated hardware chip for AI, or may be a general purpose processor of the related art (e.g., a central processing unit (CPU) or an application processor (AP)), or a graphic-exclusive processor (e.g., a GPU).

According to still another embodiment, the learning network model 270 may be made in a software module or a hardware chip type and located at an external server 260.

In this case, the cleaning robot 100 may transmit the input data for image processing to the external server 260 through the communication module 225. The input data may include, for example, images taken from a 3D depth camera (e.g., 3D depth camera 180 of FIGS. 1A and 1B) and/or a general camera (e.g., a 2D camera). The image photographed by the 3D depth camera (for example, the 3D depth camera 180 of FIGS. 1A and 1B) may include depth information between the photographed image and the subject included in the image. The external server 260 inputs the image data received from the cleaning robot 100 to the learning network model 270 to find an image similar to the inputted image and transmit the image to the communication module 225 of the cleaning robot 100.

When the learning network model 270 located in the external server 260 is implemented as a software module, the learning network model 270 may be stored in a computer-readable recording medium. In this case, the computer-readable recording medium may be a memory of the server 260.

The learning network model 270 may be generated in an external server 260. The server 260 can be, for example, a server of a maker of the cleaning robot 100, a server of an administrator, or a server of a third party that the manufacturer or manager has commissioned or leased. The server 260 may be a server that only creates or updates the learning network model 270 and receives input data from the cleaning robot 100 and provides the estimated results using the learning network model 270.

The server 260 can make the learning network model learn using the learning data. The learning data may be at least one of the shape of the object, the distance information to the object, and the kind of the object. The learning data may be collected by the manufacturer or the manager of the cleaning robot 100, or the result obtained by the cleaning robot 100 using the learning network model 270 may be used again as learning data.

The learning network model 270 may be updated periodically or non-periodically. In the case of non-periodically updating, for example, there may be a request from an administrator or a case where learning data is collected over a certain capacity.

According to various embodiments, the generation process of the learning network model 270 may be performed directly in the cleaning robot 100. For example, the cleaning robot 100 can perform the learning, updating, and image processing using the learning network model 270.

In addition, the server 260 may include a plurality of servers. The plurality of servers may include, for example, a cloud server. The cloud server may include a system for storing and processing data using resources of various devices (i.e., servers, clients, and the like) connected to each other in the Internet environment.

In addition, the learning network model 270 may exist simultaneously in the memory (not shown) of the server 260 and the memory 230 of the cleaning robot 100. In this case, the cleaning robot 100 can utilize the learning network model 270 located in the server 260 and the learning network model 270 located in the cleaning robot 100 simultaneously or sequentially.

FIGS. 2B and 2C illustrate a situation to update a learning network model by reflecting data recognition using a learning network model and a data recognition result to a learning network model again according to various embodiments of the disclosure.

FIG. 2B is a block diagram of the cleaning robot according to another embodiment. FIG. 2C is a data table which the cleaning robot stores.

Referring to FIG. 2B, the cleaning robot 101 may include a processor 280, a sensor module 285, a camera module 295, and a memory 290. The cleaning robot 100 may include the cleaning robot 101 of FIG. 2B. The processor 280, the sensor module 285, the camera module 295 and the memory 290 may correspond to the processor 210, the sensor module 215, the camera module 220 and the memory 230 of FIG. 2A.

According to one embodiment, the sensor module 285 and/or the camera module 295 may obtain distance information (e.g., distance values) with an object located outside the cleaning robot based on control of the processor 280. For example, the cleaning robot 101 may acquire a distance value with respect to an external object using the LiDAR sensor included in the sensor module 285. In addition, the cleaning robot 101 may obtain a distance value with respect to each point included in the outer shape of the object by using the 3D depth camera included in the camera module 295.

According to one embodiment, the processor 280 may derive the outer shape of the object using the distance values to each point included in the outer shape of the received object. In this case, the processor 280 may select the smallest value among the measured distance values as representative distance values between the cleaning robot 101 and the object. However, the method of selecting the representative distance value by the processor 280 is not limited thereto.

The processor 280 may compare the outer shape of the object and the representative distance value with the data table 295 of FIG. 2C stored in the memory 290. For example, the processor 280 may compare the shape of the object with the shape in the data table 295 to select data having a similar shape. In this case, the processor 280 may also compare representative distance values. The processor 280 may use the representative distance value to distinguish whether the object received from the sensor module 285 and/or the camera module 295 is an image taken by the object or an actual object.

For example, if the outer shape of the object is “a shape of a human raising the hand”, the processor 280 may determine (or estimate) an outer shape of the object as “human” based on the comparison with the data table.

The processor 280 may estimate the object as “human” based on, for example, a general shape of an object, a circular shape located at the top of the object, “T” shape contained in a circular shape, a rectangular shape located below a circular shape, and a shape of four rectangles connected to the shape of the rectangle and having a narrower width and longer length than the rectangle. For example, the processor 280 can estimate the object as a “person” based on the configuration and characteristics of each part constituting the outer shape of the object, even if there is no human's hand on the data table 295. The processor 280 may reflect the estimated result to the data table.

Referring to FIG. 2C, the cleaning robot 100 may store the updated data table 297. When the updated data table 297 is compared with the data table 295 of the related art, data on “a shape of the hand-raising human” can be newly added.

As described, the cleaning robot 100 may estimate a shape of an object included in a newly-recognized image using a pre-learned data table and learn the estimated data.

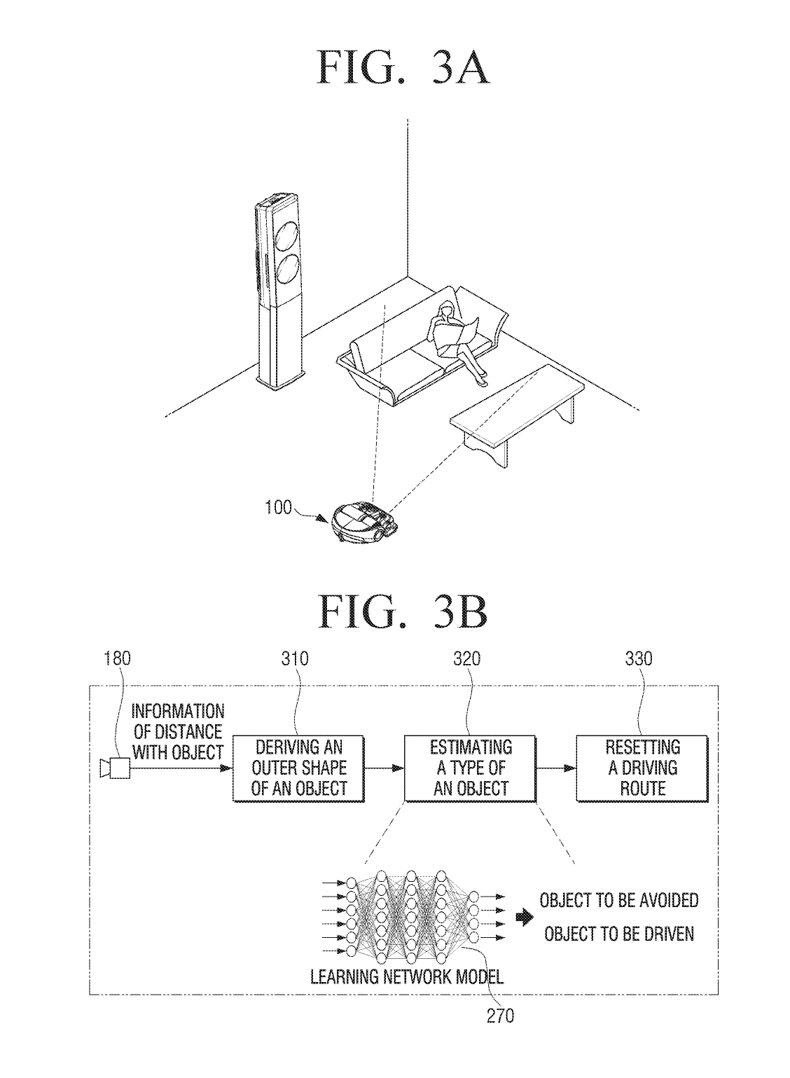

FIGS. 3A and 3B illustrate a process for determining a type of an object by a cleaning robot according to various embodiments of the disclosure.

Referring to FIG. 3A, the cleaning robot 100 may use a 3D depth camera (e.g., 3D depth camera 180 of FIGS. 1A and 1B) or rotating LiDAR sensor to obtain at least one image including distance information with the object located at an outside of the cleaning robot 100. For example, the cleaning robot 100 may obtain a distance value with respect to an object located on a driving route. The cleaning robot 100 can derive the shape of the object based on the obtained distance value and reflect it on the driving route.

Specifically, referring to FIG. 3B, the distance information with respect to the object may mean, for example, the distance between each point of the outer shape of the object and the 3D depth camera or the rotary LiDAR sensor. Each point of the outer shape of the object may be, for example, the point where the line and line meet when extracting the edge component of the outer shape of the object, or may be a point selected every predetermined distance along the outer shape. Accordingly, the cleaning robot 100 can acquire at least one image including a plurality of distance information for one object.

In this case, the cleaning robot 100 may select a smallest value from among the measured distance value as a representative distance value with the object. However, a method for selecting a representative distance value of the cleaning robot 100 is not limited thereto.

The cleaning robot 100 according to an embodiment may perform an operation 310 of deriving an outer shape of an object based on a plurality of distance information acquired for one object. For example, the cleaning robot 100 calculates a distance value between each point of the object included in the image and a cleaning robot (for example, a sensor module or a camera module), and calculates the outer shape of the object. Then, the cleaning robot 100 estimates the type of the object based on the shape of the derived object, and performs a process 320 for dividing the object into an “object to be avoided” (indicating that the cleaning robot avoids this object while cleaning) and an “object to be driven” (indicating that the cleaning robot does not avoid this object and keeps driving).

The object to be avoided may be, for example, an object adjacent to the object and unable to perform cleaning. For example, it may include people, animals, animal excrement, and the like. The object to be driven may be, for example, an object that needs to be cleaned adjacent to the object. For example, walls, stairs, pillars, furniture, and the like, may be included.

For example, if the object type is the object to be avoided, the cleaning robot 100 may perform a process 330 for resetting the moving route in progress. For example, the cleaning robot 100 can reset the moving route so that cleaning can be performed while maintaining a predetermined distance from the object. In this case, when the object to be avoided is an object that does not move, the cleaning robot 100 may reflect the position of the object to be avoided in the moving route map stored in the memory. For example, the cleaning robot 100 may reflect the position of the object to be avoided in the moving route map created by using the position recognition camera which photographs the moving trace of the cleaning robot 100. For this reason, the cleaning robot 100 may not calculate the distance to the object to be avoided repeatedly.

For example, when the type of the object is the object to be driven, the cleaning robot 100 can maintain the moving route in progress. For example, the cleaning robot 100 may move to a point adjacent to the object. The cleaning robot 100 may perform cleaning while approaching the object to a predetermined distance by using a separate proximity sensor.

The type of the object to be avoided or the object to be driven can be determined by the processor 210 included in the cleaning robot 100. However, according to one embodiment, the cleaning robot 100 may perform a process of estimating the type of object using the learning network model 270 set to estimate the type of the object. In this case, the learning network model 270 may include, for example, an artificial intelligence neural network model or a deep learning network model. Once the type of object is estimated using the learning network model 270, the cleaning robot 100 can reset or maintain an ongoing route according to the estimated type.

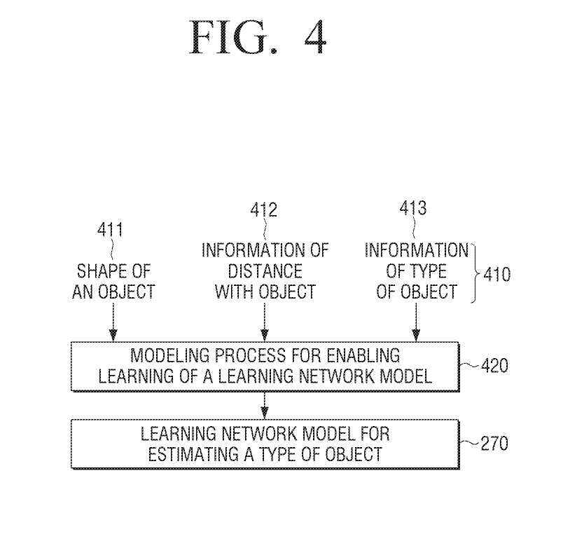

FIG. 4 is a diagram illustrating a process of generating a learning network model (for example, a deep learning network) according to an embodiment of the disclosure.

Referring to FIG. 4, a modeling process 420 for enabling learning of a learning network model may be performed based on the learning data 410. In this case, the learning data 410 may include at least one of, for example, the shape 411 of the object, the distance information 412 to the object, and the type information 413 of the object. The shape 411 of the object may mean, for example, the outer shape of an object that can be photographed while the cleaning robot is driving. For example, walls, furniture, people, animals, animal excreta, stairs, and pillars may be included in the shape 411 of the object. The shape of the object may include a 3D image. In addition, the learning data 410 may include distance information 412 between the photographing device and the object used when the 3D image is generated.

In addition, the object type information 413 may include, for example, whether the type of the object is a type in which the cleaning robot is required to maintain the cleaning route or a type in which the route is to be reset for driving while avoiding.

When the modeling process 420 is performed, the learning network model 270 which is configured to estimate a type of an object as a result of the modeling process can be derived.

In addition, the object type information 413 may be, for example, information about whether the type of the object is a type in which the cleaning robot is required to maintain the cleaning route or a type in which the route must be reset for avoidance driving. Once the modeling process 420 is performed, a learning network model 270 configured to estimate the type of object may be derived as a result. The cleaning robot 100 according to an embodiment can select the object type based on the data stored in the memory (e.g., the memory 230 in FIG. 2A) and can also use the learning network model 270 described above to estimate the type of the object.

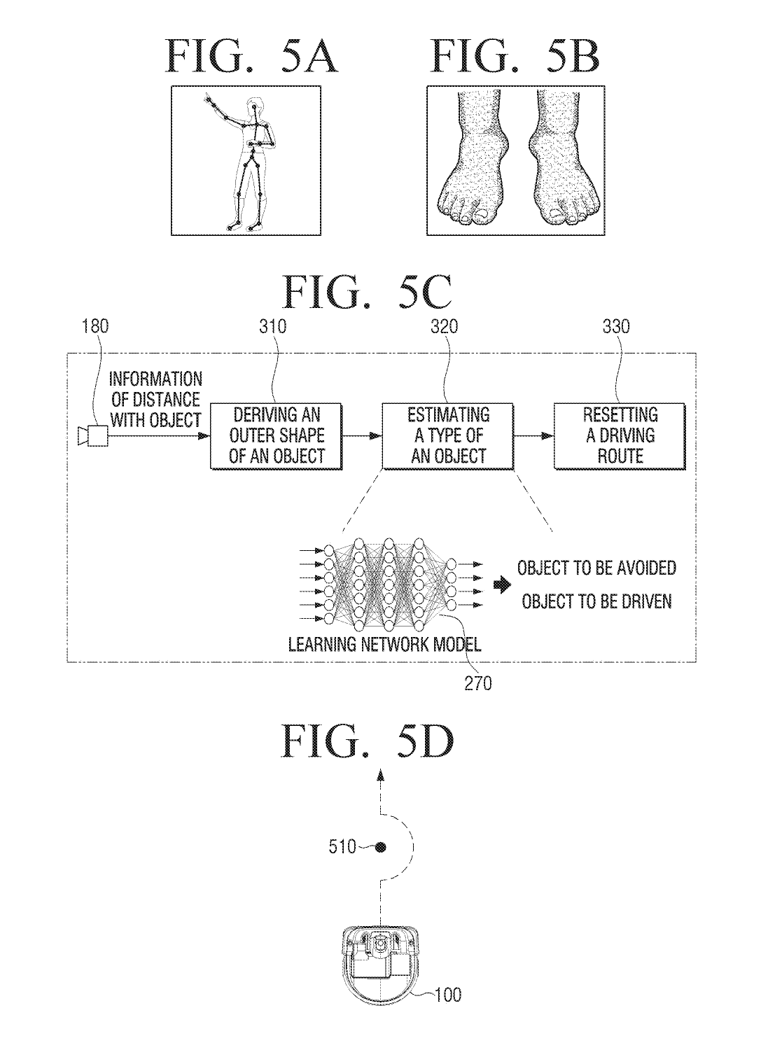

FIGS. 5A, 5B, 5C, and 5D illustrate a situation of detecting an object by a cleaning robot and resetting a driving route according to an embodiment of the disclosure.

FIGS. 5A and 5B are diagrams for explaining a situation in which the cleaning robot 100 derives the shape of an object. Referring to FIG. 5A, the cleaning robot 100 scans a skeleton image of a person based on a photographed image using a 3D depth camera (for example, the 3D depth camera 180 of FIGS. 1A and 1B). For example, the cleaning robot 100 may extract the characteristic points of the body using a 3D depth camera (e.g., the 3D depth camera 180 of FIGS. 1A and 1B), and derive the characteristic points of each part constituting the human body, for example, arms, legs, torso, face, and so on.

Referring to FIG. 5B, the cleaning robot 100 uses a 3D depth camera (for example, the 3D depth camera 180 of FIGS. 1A and 1B) or a rotatable LiDAR sensor to detect a human foot part as a 3D image.

Referring to FIG. 5C, the cleaning robot 100 may perform an operation 310 of deriving an object shape based on distance information with respect to an object. The cleaning robot 100 may perform a process 320 of estimating the type of the object using the image derived from the outer shape. For example, the cleaning robot 100 may compare the shape of an object derived by a processor (e.g., the processor 210 of FIG. 2A) with data stored in a memory (e.g., memory 230 of FIG. 2A) to estimate a type of the object. In addition, the cleaning robot 100 can input the distance information between the outer shape and the object as input data to the learning network model 270. The learning network model 270 can estimate the type of the object based on the input data.

To be specific, the learning network model 270 may estimate a type of an object by summing up the result of applying the weight of the network node to the input data for each network depth.

The above-described process of estimating the type of the object by the cleaning robot 100 can be expressed by the following equation.

$$S = {\sum }_{n = 1}^{{N}_{Network Depth}} ( {\sum }_{{k}_{1}}^{{K}_{1}} {W}_{{k}_{1}} ( {\sum }_{{k}_{2}}^{{K}_{2}} {W}_{{k}_{2}} ( … {\sum }_{{k}_{N}}^{{K}_{N}} {W}_{{k}_{N}} {I}_{input} ) ) ) \qquad Equation 1$$

In the Equation, S indicates a type of the estimated object.

W represents a weight of network nodes constituting the learning network model 270 for estimating the type of object, and Iᵢₙₚᵤₜ represents input data (for example, input data 410 of FIG. 4).

The cleaning robot 100 may perform the process 330 of resetting the driving route based on a type of the estimated object.

Referring to FIG. 5D, when the object type is the object to be avoided, the cleaning robot 100 can reset the moving route in progress. For example, the cleaning robot 100 can reset the moving route so that cleaning can be performed while maintaining a predetermined distance from the object. To this end, the cleaning robot 100 may reflect the position of the object to be avoided in the moving route map stored in the memory. For this reason, the cleaning robot 100 may not calculate the distance to the object to be avoided repeatedly.

Specifically, when the type of the object is estimated as a person among the object to be avoided, the cleaning robot 100 can set the avoidance radius to 50 cm and reset the moving route. For example, the cleaning robot 100 can perform avoidance driving while keeping the distance to the human at 50 cm.

In this case, the cleaning robot 100 may change the suction power or the power of the brush to 80%. For example, when the cleaning robot 100 is adjacent to a human, the cleaning robot 100 can reduce the noise caused by cleaning. However, it is not limited thereto. For example, when the type of the object is the object to be driven, the cleaning robot 100 can maintain the moving route in progress. For example, the cleaning robot 100 may move to a point adjacent to the object. The cleaning robot 100 may perform cleaning while approaching the object to a predetermined distance by using a separate proximity sensor. According to various embodiments, the cleaning robot 100 can increase the accuracy of detection by using a separate sensor. For example, the cleaning robot 100 may further include an infrared motion detection sensor to detect a change in infrared heat to detect a human approach. In addition, the cleaning robot 100 can detect a human's voice by using a microphone and detect a person's approach.

According to various embodiments, when the type of object detected by the cleaning robot 100 is estimated as an object to be avoided and the moving route is reset, a notification signal can be generated. For example, the cleaning robot 100 may display a user interface that informs the display (e.g., display 255 of FIG. 2A) that the moving route has been reset.

In addition, the cleaning robot 100 may output an audio signal indicating that the driving route has been reset to the user by using a component capable of outputting sound, such as an audio output module (not shown).

In addition, in accordance with various embodiments, the cleaning robot 100 may use a communication module (for example, the communication module 225 in FIG. 2A) to communicate with other electronic devices (for example, a smart phone, a television (TV), a refrigerator, and the like) to inform that the driving route is reset. Therefore, the user can easily recognize the moving route change state of the cleaning robot 100 even if the user is not in the vicinity of the cleaning robot 100.

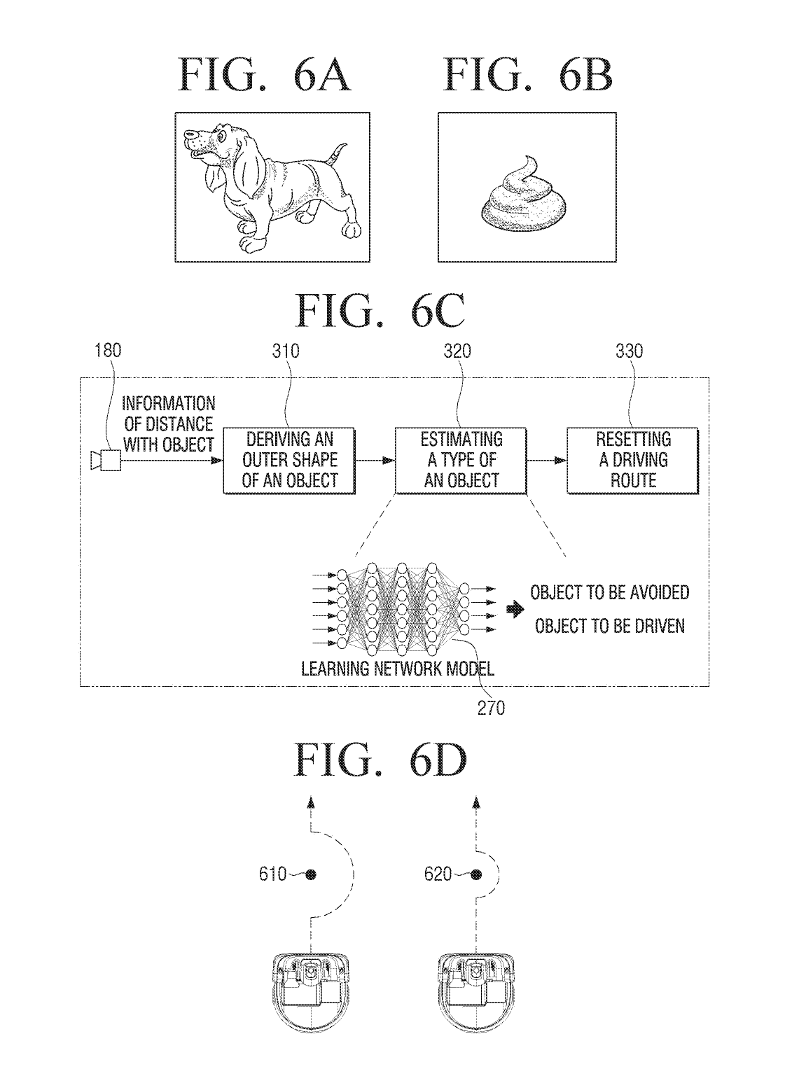

FIGS. 6A, 6B, 6C, and 6D illustrate a situation of detecting an object by a cleaning robot and resetting a driving route according to various embodiments of the disclosure.

FIGS. 6A and 6B illustrate a situation of driving a shape of an object of the cleaning robot 100.

Referring to FIG. 6A, the cleaning robot 100 may generate a 3D image with respect to an outer shape of an animal (e.g., a dog) based on an image photographed using the 3D depth camera (e.g., 3D depth camera 180 of FIG. 1) or rotatable LiDAR sensor. Referring to FIG. 6B, the cleaning robot 100 may generate a 3D image with respect to excreta (e.g., excreta of an animal) using the 3D depth camera 180 or the rotatable LiDAR sensor.

Referring to FIG. 6C, the cleaning robot 100 may perform an operation 310 of deriving an object shape based on distance information with respect to an object. The cleaning robot 100 may perform a process 320 of estimating the type of the object using the image derived from the outer shape. For example, the cleaning robot 100 may estimate the type of an object by comparing the shape of an object derived by the processor 210 with data stored in a memory (e.g., memory 230 in FIG. 2A). In addition, the cleaning robot 100 can input the distance information between the outer shape of the object and the object as input data to the learning network model 270. The learning network model 270 can estimate the type of the object based on the input data.

Specifically, the learning network model 270 may estimate the type of object by adding the result of applying the weight of the network node to the input data for each network depth. For example, the cleaning robot 100 may estimate the type of object using the above-described Equation.

The cleaning robot 100 may perform a process 330 to reset a driving route based on a type of the estimated object.

Referring to FIG. 6D, when the object type is the object to be avoided, the cleaning robot 100 can reset the moving route in progress. For example, the cleaning robot 100 can reset the moving route so that cleaning can be performed while maintaining a predetermined distance from the object. To this end, the cleaning robot 100 may reflect the position of the object to be avoided in the moving route map stored in the memory. For this reason, the cleaning robot 100 may not calculate the distance to the object to be avoided repeatedly.

Specifically, when the type of object is estimated as an animal 610 (e.g., a dog, a cat, and the like) among the objects to be avoided, the cleaning robot 100 can set the avoidance radius to 100 cm and reset the moving route. For example, the cleaning robot 100 can avoid driving while maintaining the distance from the animal to 100 cm.

In this case, the cleaning robot 100 may change the suction power or the power of the brush to 50%. For example, when the cleaning robot 100 is adjacent to an animal, it is possible to reduce noise generated by cleaning. Thereby, it is possible to reduce the situation in which the animal is irritated due to the cleaning operation of the cleaning robot 100, and also to reduce the situation in which the animal is brought into contact with the cleaning robot 100 to cause damage to the cleaning robot 100.

In addition, when the type of the object is estimated to be the excrement 620 (e.g., animal excrement), the cleaning robot 100 may set the avoidance radius to 30 cm and reset the moving route.

In this case, the cleaning robot 100 may set the suction power or the brush power to 100% and perform cleaning operation in progress.

For example, when the object type is the object to be driven, the cleaning robot 100 can maintain the moving route in progress. For example, the cleaning robot 100 may move to a point adjacent to the object. The cleaning robot 100 can perform cleaning while approaching the object to a predetermined distance using a separate proximity sensor.

As described above, the cleaning robot 100 according to the embodiment can set various driving route according to the types of the detected objects, and can smoothly adjust the suction force and the like of the cleaning robot 100 so that cleaning can be performed efficiently.

According to various embodiments, the cleaning robot 100 can increase the detection accuracy by using a separate sensor. For example, the cleaning robot 100 may further include an infrared motion detection sensor to detect an infrared thermal change to detect the approach of the animal. In addition, the cleaning robot 100 can detect the approach of the animal by sensing the sound of the animal using a microphone.

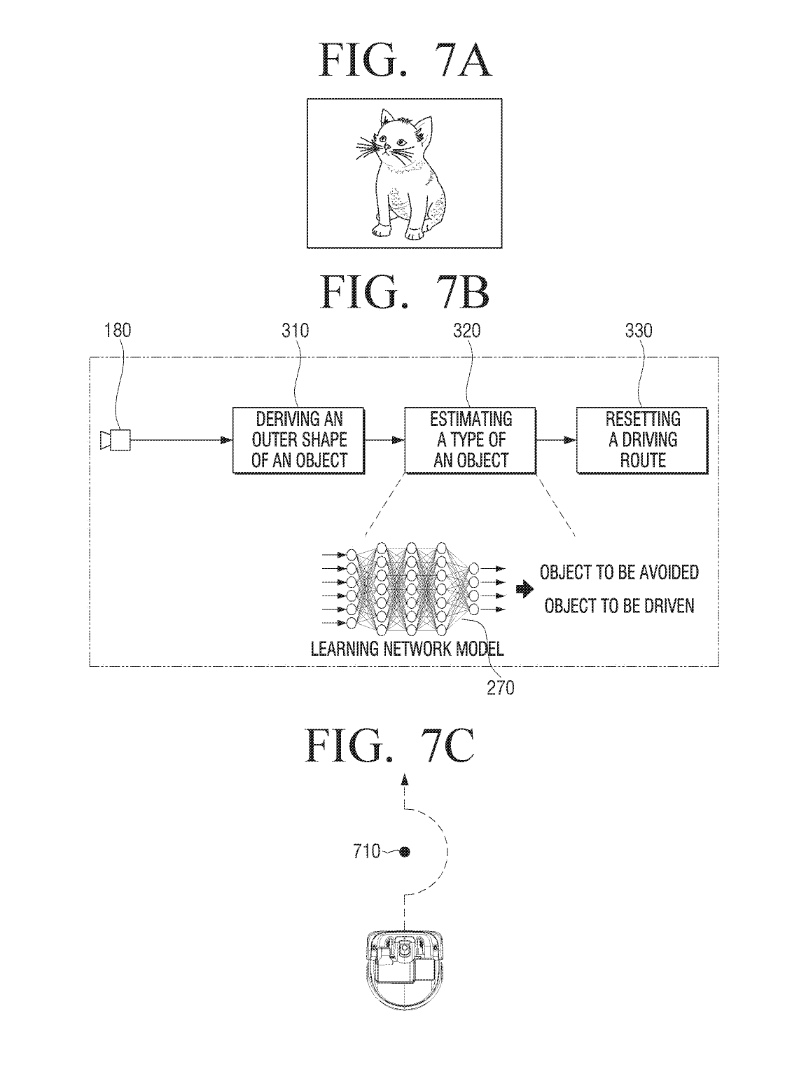

FIGS. 7A, 7B, and 7C illustrate a situation of detecting an object by a cleaning robot and resetting a driving route according to various embodiments of the disclosure.

Referring to FIG. 7A, the cleaning robot 100 may photograph an image of a cat.

Referring to FIG. 7B, the cleaning robot 100 may perform an operation 310 of deriving an object shape using an image analysis algorithm or the like. For example, the cleaning robot 100 may convert the captured image of the cat into an image that emphasizes the edge, and then extract the edge component to derive the outer shape of the cat.

The cleaning robot 100 may perform a process 320 of estimating the type of the object using the image derived from the outline. For example, the cleaning robot 100 may estimate the type of an object by comparing the shape of an object derived by the processor 210 with data stored in a memory (e.g., memory 230 in FIG. 2A). In addition, the cleaning robot 100 can input the outer shape of the object into the learning network model 270 as input data. The learning network model 270 can estimate the type of the object based on the input data.

More specifically, the learning network model 270 can estimate the type of object by summing the result of applying the weight of the network node to the input data for each network depth.

The cleaning robot 100 may perform a process 330 to reset a driving route based on a type of the estimated object.

Referring to FIG. 7C, when the object type is the object to be avoided, the cleaning robot 100 can reset the driving route in progress. For example, the cleaning robot 100 can reset the driving route so that cleaning can be performed while maintaining a predetermined distance from the object. To this end, the cleaning robot 100 may reflect the position of the object to be avoided in the moving route map stored in the memory. For this reason, the cleaning robot 100 may not calculate the distance to the object to be avoided repeatedly.

Specifically, when the type of the object is estimated as an animal 710 (e.g., a cat) among the objects to be avoided, the cleaning robot 100 can set the avoidance radius to 100 cm and reset the driving route. That is, the cleaning robot 100 can perform avoidance driving while keeping the distance from the cat by 100 cm.

In this case, the cleaning robot 100 may change the suction power or the power of the brush to 50%. That is, when the cleaning robot 100 is adjacent to an animal, it is possible to reduce noise generated by cleaning. Thereby, it is possible to reduce the situation in which the animal is irritated due to the cleaning operation of the cleaning robot 100, and also to reduce the situation in which the animal is brought into contact with the cleaning robot 100 to cause damage to the cleaning robot 100.

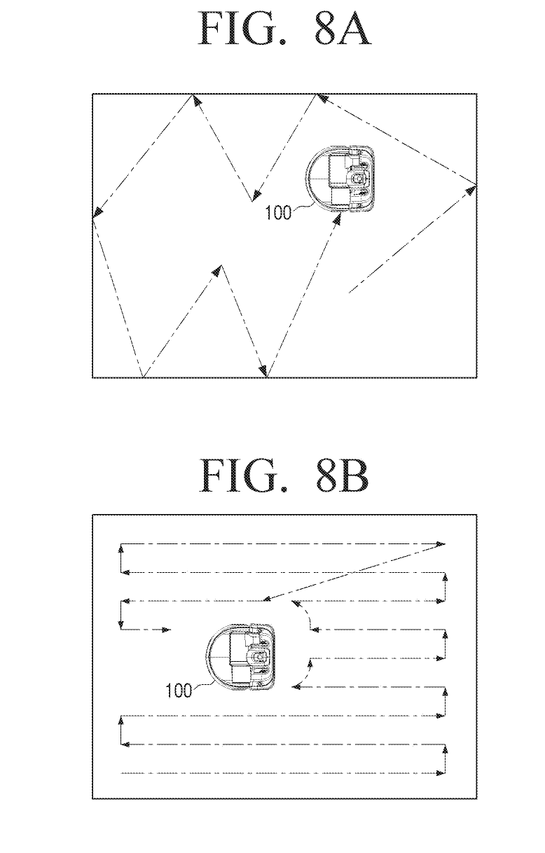

FIGS. 8A and 8B illustrate a driving method of a cleaning robot according to various embodiments of the disclosure.

Referring to FIGS. 8A and 8B, the cleaning robot 100 according to an embodiment may include a plurality of driving modes. For example, the driving method of the cleaning robot 100 may include a random driving method and a pattern driving method.

In the random driving mode, for example, when an obstacle is detected using an obstacle sensor (e.g., an infrared sensor, an ultrasonic sensor, and the like) during straight driving, or cleaning is performed while changing a driving route when a collision with an obstacle occurs, cleaning can be performed while changing a driving route. When the cleaning robot 100 moves in the random driving mode, a map for cleaning is not used.

The pattern driving method is a method of using a map for cleaning. For example, the cleaning robot 100 can correct its coordinate value using data collected through a camera, a LiDAR sensor, or the like. The map for cleaning can store information, such as the presence of an obstacle, the presence or absence of cleaning, and the location of a charger. Therefore, it may be possible to confirm whether the entire area is cleaned.

A map for cleaning can be generated while the cleaning robot 100 is driving in advance and the cleaning robot 100 can perform a cleaning operation by using a camera, a LiDAR sensor, or the like located at the upper end of the cleaning robot 100.

FIG. 8A is a diagram showing the object to be avoided while the cleaning robot 100 performs the cleaning by the random driving method, and resets the moving route according to an embodiment of the disclosure. In this case, when the cleaning robot 100 finds the object to be avoided, it can change the driving route in the other direction.

FIG. 8B is a view showing the object to be avoided while the cleaning robot 100 performs the cleaning by the pattern driving method, and resetting the moving route according to an embodiment of the disclosure. In this case, when the cleaning robot 100 finds the object to be avoided, it can reset the moving route by avoiding the object to be avoided while drawing a circle around the object to be avoided.

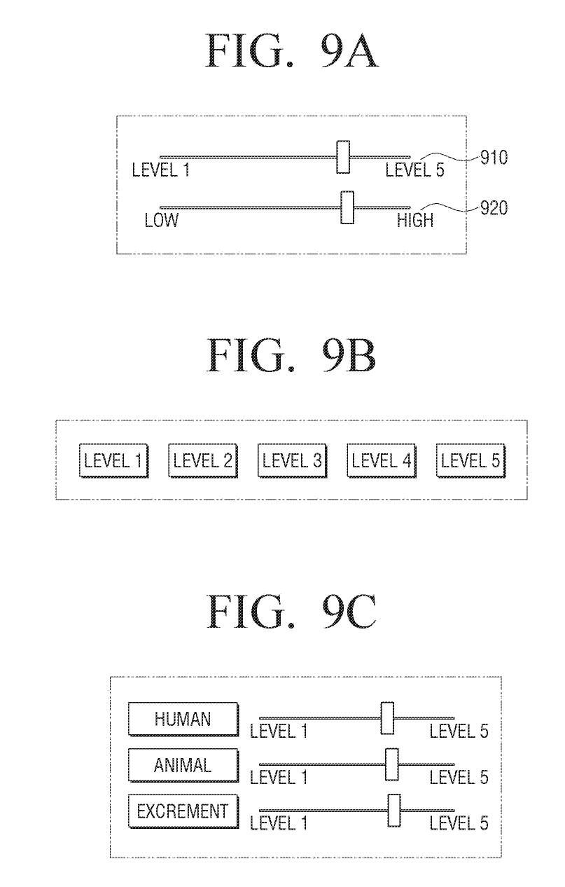

FIGS. 9A, 9B, and 9C illustrate a user interface (UI) for adjusting a degree of driving route resetting of a cleaning robot according to various embodiments of the disclosure.

The degree of the route resetting may mean, for example, the distance by which the cleaning robot 100 avoids the object to be avoided, and also means the intensity of the suction force or the brush power when avoiding the object to be avoided.

For example, if the degree of resetting of the moving route is reduced, the cleaning robot 100 can reduce the distance avoiding the object to be avoided and lower the suction force or the brush power. In addition, when the driving route resetting degree is increased, the cleaning robot 100 can increase the distance avoiding the object to be avoided and increase the suction force or the brush power.

The UI for adjusting the driving route resetting degree of the cleaning robot 100 is provided through an input unit (not shown) or a display (for example, the display 255 shown in FIG. 2A) of the cleaning robot 100. It may also be provided through an input or display of an electronic device (e.g., smart phone, tablet personal computer (PC), and the like) establishing a communication relationship with the cleaning robot 100.

Referring to FIG. 9A, the cleaning robot 100 may provide a scroll bar UI so that the user can adjust the travel path resetting degree of the cleaning robot. In this case, the degree of resetting of the cleaning robot moving route that can be set by the user is provided as a number of levels as shown by 910 in FIG. 9A, or as a high/low level of the resetting degree, such as 920 of FIG. 8A.

Referring to FIG. 9B, the cleaning robot 100 may provide a button UI for a user to adjust a driving route resetting degree of the cleaning robot.

Referring to FIG. 9C, the cleaning robot 100 may provide a UI for adjusting the driving route resetting degree according to the object type. For example, the cleaning robot 100 may provide a scrolling UI that allows the number of levels to be adjusted, respectively, according to people, animals, and excreta (e.g., animal excrement). Accordingly, the user can adjust the driving route resetting degree of the cleaning robot 100 according to the desired object.

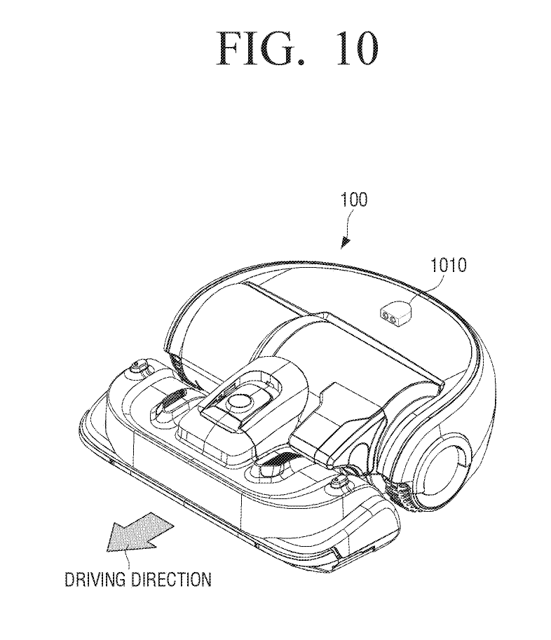

FIG. 10 illustrates a situation in which a location of a sensor for measuring distance with an object from a cleaning robot is set differently according to an embodiment of the disclosure.

According to one embodiment, when the cleaning robot 100 rotates while driving, an object may suddenly appear on the front surface of the cleaning robot 100. In this case, since the minimum measurable distance of the 3D depth camera located on the front surface of the cleaning robot 100 is not satisfied, the center portion of the input image is saturated, and it is difficult to measure the shape of the object.

Referring to FIG. 10, the cleaning robot 100 may provide a sensor 1010 (e.g., 3D camera, rotating LiDAR sensor, and the like) for measuring distance with an object at a position (e.g., a rear side of an upper end of the cleaning robot 100) which is opposite to a driving direction of the cleaning robot 100.

When the position of the 3D depth camera is changed, even when the cleaning robot 100 suddenly rotates and an object appears on the front surface of the cleaning robot 100, the 3D depth camera 1010 can maintain a certain distance from the object.

By the above, the cleaning robot 100 may obtain the distance information from the object and derive a shape of the object.

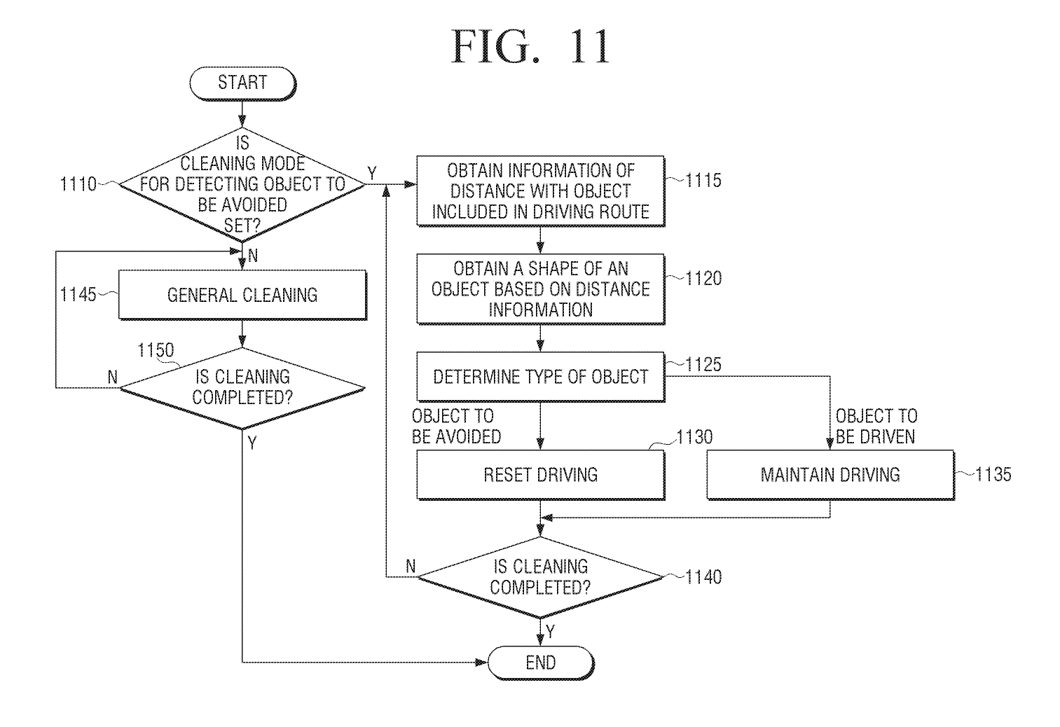

FIG. 11 is a flowchart illustrating a driving method of a cleaning robot according to an embodiment of the disclosure.

Referring to FIG. 11, in operation 1110, the cleaning robot 100 may identify whether the cleaning mode for detecting the object to be avoided is activated.

Referring to operation 1115, when the cleaning mode for detection an object to be avoided is activated, the cleaning robot 100 can acquire distance information with respect to objects included in the moving route. The cleaning robot 100 may acquire distance information with respect to an object located on the driving route of the cleaning robot 100, for example, using a 3D depth camera or a rotary LiDAR sensor.

The distance information to the object may mean, for example, the distance between each point of the outer shape of the object and the 3D depth camera or the rotary LiDAR sensor. Accordingly, the cleaning robot 100 can acquire a plurality of pieces of distance information for one object.

Referring to operation 1120, the cleaning robot 100 may acquire the shape of the object based on the obtained distance information.

Referring to operation 1125, the cleaning robot 100 may determine the type of object based on the shape of the object. The cleaning robot 100 can classify the object type into the object to be avoided and the object to be driven based on the shape of the derived object.

According to one embodiment, the cleaning robot 100 can determine the type of object by comparing the shape of the object with the data stored in the memory. In addition, the cleaning robot 100 may perform estimating a type of an object using the leaning network model 270 which is set to estimate a type of the object. In this case, the learning network model 270 may include, for example, an artificial intelligence neural network model or a deep learning network model.

Referring to operation 1130, when the object type is the object to be avoided, the cleaning robot 100 can reset the driving route in progress. Referring to operation 1035, when the type of the object is the object to be driven, the cleaning robot 100 can maintain the route in progress.

The object to be avoided may be, for example, an object adjacent to the object and unable to perform cleaning. For example, it may include people, animals, animal excrement, and the like. The object to be driven may be, for example, an object that needs to be cleaned adjacent to the object. For example, walls, stairs, pillars, furniture, and the like, may be included.

Referring to operation 1140, the cleaning robot 100 can determine whether cleaning is completed. When the cleaning is completed (1040—Y), the cleaning robot 100 finishes the cleaning and can return to the place where the charger is located. When the cleaning is not completed (1040—N), the cleaning robot can repeat the above-described process while maintaining the driving.

If the cleaning robot 100 does not activate the object detection and cleaning mode at operation 1110, referring to operation 1145, the cleaning robot 100 may proceed to the general cleaning driving mode.

Referring to operation 1150, the cleaning robot 100 can determine whether cleaning has been completed. When the cleaning is completed (1150—Y), the cleaning robot 100 finishes the cleaning and can return to the place where the charger is located. If the cleaning is not completed (1150—N), the cleaning robot 100 can maintain normal cleaning driving.

The disclosed embodiments may be implemented in a software program including commands stored on a computer-readable storage medium.

The computer is a device capable of calling stored commands from a storage medium and operating according to an embodiment disclosed according to the called command, and may include the cleaning robot 100 or an external server which is communicably connected with the cleaning robot 100.

A computer-readable storage media may be provided in the form of non-transitory storage media. Here, ‘non-temporary’ means that the storage medium does not include a signal and is tangible, but does not distinguish whether data is permanently or temporarily stored in a storage medium.

In addition, the control method according to the disclosed embodiments can be provided in a computer program product. A computer program product may be traded between a seller and a buyer as a commodity.

A computer program product may include a software program and a computer readable storage medium having stored therein a software program. For example, a computer program product may include a product of a cleaning robot or a product in the form of a software program electronically distributed through an electronic market (e.g., Google Play Store, App Store) (e.g., a downloadable app). For electronic distribution, at least a portion of the software program may be stored on a storage medium or may be created temporarily. In this case, the storage medium may be a server of a manufacturer, a server of an electronic market, or a storage medium of a relay server for temporarily storing a software (SW) program.

The computer program product may include a storage medium of a server or a storage medium of a cleaning robot in a system configured by a server and a cleaning robot. Alternatively, when there is a third device (e.g., a smart phone) communicatively coupled to a server or a cleaning robot, the computer program product may include a storage medium of the third device. Alternatively, the computer program product may include the S/W program itself transmitted from the server to the cleaning robot or the third device, or from the third device to the cleaning robot.

In this case, one of the server, the cleaning robot, and the third device may execute the computer program product to perform the method according to the disclosed embodiments. Alternatively, two or more of the server, the cleaning robot, and the third device may execute the computer program product to distribute the method according to the disclosed embodiments.

For example, a server (e.g., a cloud server or an artificial intelligence server, and the like) may run a computer program product stored on a server to control a cleaning robot connected to the server to perform a method according to the disclosed embodiments.

As another example, the third device may execute a computer program product to control the cleaning robot connected to and communicating with the third device to perform the method according to the disclosed embodiment. When the third device executes the computer program product, the third device can download the computer program product from the server and execute the downloaded computer program product. Alternatively, the third device may execute a computer program product provided in a preloaded manner to perform the method according to the disclosed embodiments.

The non-transitory computer-recordable medium is not a medium configured to temporarily store data, such as a register, a cache, or a memory but an apparatus-readable medium configured to semi-permanently store data. Specifically, the above-described various applications or programs may be stored in the non-transitory apparatus-readable medium, such as a compact disc (CD), a digital versatile disc (DVD), a hard disc, a Blu-ray disc, a universal serial bus (USB), a memory card, or a read only memory (ROM), and provided therein.

Certain aspects of the disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the disclosure can be easily construed by programmers skilled in the art to which the disclosure pertains.

At this point it should be noted that the various embodiments of the preset disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the disclosure as described above. Alternatively, one or more processors operating in accordance with stored instructions may implement the functions associated with the various embodiments of the disclosure as described above. If such is the case, it is within the scope of the disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the disclosure can be easily construed by programmers skilled in the art to which the disclosure pertains.

While the disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A cleaning robot comprising:
a distance measuring sensor configured to measure distance information to an object located outside the cleaning robot;
a memory configured to store a shape of the object, the distance information, and a plurality of commands based on the distance information to the object which is measured through the distance measuring sensor; and
a processor configured to:
when the cleaning robot is operated, estimate a type of the object by applying the shape of the object and the distance information stored in the memory to a learning network model configured to estimate a type of the object,
when the object is in a type that the object is to be avoided, re-set a driving route of the cleaning robot, and
when the type of the object is an object to be driven, maintain a current driving route of the cleaning robot,
wherein the learning network model which is configured to estimate the type of the object is a learning network model which learns using a shape of the object, distance information to the object, and information of a type of the object.

2. The cleaning robot of claim 1, wherein the processor is further configured to estimate a type of the object according to operation based on a connection relation among a plurality of network nodes constituting the learning network model and each weight of the plurality of network nodes.

3. The cleaning robot of claim 1, wherein the processor, when a user input to adjust a degree of re-setting the driving route is received, is further configured to re-set a driving route of the cleaning robot based on the degree of re-setting which is adjusted according to the user input while the cleaning robot is being operated.

4. The cleaning robot of claim 1, wherein the processor, when the learning network model is stored in a memory of the external server, is further configured to estimate, when the cleaning robot is operated, a type of the object by inputting the distance information to the object and the shape of the object to the learning network model stored in the external server.

5. The cleaning robot of claim 1, wherein the processor, when the learning network model is stored in a memory of the external server and the memory, is further configured to estimate, when the cleaning robot is operated, a type of the object by inputting the distance information to the object and the shape of the object to the learning network model stored in the external server and the memory.

6. The cleaning robot of claim 1, wherein the processor, when the driving route of the cleaning robot is re-set, is further configured to control to drive the cleaning robot while maintaining a distance with the object subject to avoidance in a circle shape from a position of the object subject to avoidance.

7. The cleaning robot of claim 1, wherein the processor, while the cleaning robot is being operated, when a driving route of the cleaning robot is reset, is further configured to adjust at least one of suction power and brush power of the cleaning robot.

8. The cleaning robot of claim 1, wherein the distance measuring sensor is disposed at an upper end of the cleaning robot which is adjacent to the driving direction of the cleaning robot or at an upper end which is adjacent to an opposite direction of the driving direction of the cleaning robot.

9. A cleaning robot comprising:
a distance measuring sensor configured to measure distance information to an object located outside the cleaning robot;
a memory configured to store a shape of the object, the distance information, and a plurality of commands based on the distance information to the object which is measured through the distance measuring sensor;
a processor configured to:
when the cleaning robot is operated, select a type of object to which a shape of the object is belonging to, the shape being derived based on distance information to the object measured through the distance measurement sensor,
when the object is in a type that the object is to be avoided, re-set a driving route of the cleaning robot, and
when the type of the object is an object to be driven, maintain a current driving route of the cleaning robot.

10. The cleaning robot of claim 9, wherein the distance measuring sensor is disposed at an upper end of the cleaning robot which is adjacent to the driving direction of the cleaning robot or at an upper end which is adjacent to an opposite direction of the driving direction of the cleaning robot.

11. A controlling method of a cleaning robot, the method comprising:
obtaining distance information to an object located at outside of the cleaning robot;
deriving a shape of the object based on distance information to the object;
estimating a type of the object by applying the distance information and the shape of the object to a learning network model configured to estimate a type of an object;
when the estimated type of the object is of an object to be avoided, resetting a driving route of the cleaning robot, and
when the estimated type of the object is of an object to be driven, maintaining a current driving route of the cleaning robot,
wherein the learning network model which is set to estimate a type of the object is a learning network model which is learnt using a shape of an object, distance information to the object, and information of the type of the object.

12. The method of claim 11, wherein the estimating of the type of the object comprises estimating a type of the object according to operation based on a connection relation among a plurality of network nodes constituting the learning network model and a weight of each of the plurality of network nodes.

13. The method of claim 11, wherein the resetting of the driving route of the cleaning robot further comprises:
receiving a user input to adjust a degree of resetting of the driving route, and
resetting a driving route of the cleaning based on the degree of resetting adjusted according to the user input.

14. The method of claim 11, wherein, when the learning network model is stored in a memory of the external server, the estimating of the type of the object comprises:
estimating a type of the object by inputting the distance information to the object and the shape of the object to the learning network model stored in the external server.

15. The method of claim 11, wherein, when the learning network model is stored in the external server and the memory, the estimating of the type of the object comprises:
estimating a type of the object by inputting the distance information to the object and the shape of the object to the learning network model stored in the external server and the memory.

16. The method of claim 11, wherein the resetting of the driving route of the cleaning robot comprises:
driving the cleaning robot while maintaining a distance to the object subject to avoidance in a circle shape from a position of the object to be avoided.

17. The method of claim 11, wherein the resetting of the driving route of the cleaning robot comprises:
adjusting at least one of a suction power or a brush power of the cleaning robot.
